(19) United States
(12) Patent Application Publication
(10) Pub. No.: US 2016/0081279 A1
(43) Pub. Date: Mar. 24, 2016

(54) Automatic Liquid Supply Planting Device

(71) Applicant: Wen-Chi Lai, Taichung City (TW)

(72) Inventor: Wen-Chi Lai, Taichung City (TW)

(21) Appl. No.: 14/490,734

(22) Filed: Sep. 19, 2014

(51) Int. Cl. A01G 9/02; A01G 27/00

(52) U.S. Cl. CPC A01G 9/02; A01G 27/005

(57) ABSTRACT

An automatic liquid supply planting device has a base, a planting holder mounted on the base, a liquid supply module, and a bottle. The liquid supply module is mounted on the base and has a liquid supply base mounted on the base and having a liquid guiding hole. The liquid supply bottle cap is detachably mounted on the liquid supply base and has a cap body detachably inserted into the liquid supply base, a base wall annularly formed on an inner side of the cap body and located at an end of the cap body, and a liquid outlet hole formed through the base wall and communicating with the liquid guiding hole. The bottle is detachably combined with the cap body and has an inner space communicating with the liquid outlet hole.

### BACKGROUND OF THE INVENTION

1. Field of the Invention

The present invention relates to a planting device, and more particularly to an automatic liquid supply planting device.

2. Description of Related Art

To avoid environmental pollution and pesticide residue, an emerging agricultural technology is developed and applied widely, especially for a new technology that plants sprouts without using pesticide, soil, and chemical fertilizers.

In the agricultural technology of planting sprouts, a continued supply of culture liquid is the most crucial but to maintain the continued supply of culture liquid is time-consuming. If the culture liquid is not regularly supplied due to forgetfulness, the sprouts may be withered and a serious loss is caused.

### SUMMARY OF THE INVENTION

The main objective of the present invention is to provide an automatic liquid supply planting device to resolve the afore-mentioned problems.

The automatic liquid supply planting device has a base, a planting holder mounted on the base, a liquid supply module, and a bottle. The liquid supply module is mounted on the base and has a liquid supply base mounted on the base and having a liquid guiding hole. The liquid supply bottle cap is detachably mounted on the liquid supply base and has a cap body detachably inserted into the liquid supply base, a base wall annularly formed on an inner side of the cap body and located at an end of the cap body, and a liquid outlet hole formed through the base wall and communicating with the liquid guiding hole. The bottle is detachably combined with the cap body and has an inner space communicating with the liquid outlet hole.

Other objectives, advantages and novel features of the present invention will become more apparent from the following detailed description when taken in conjunction with the accompanying drawings.

### BRIEF DESCRIPTION OF THE DRAWINGS

FIG. 1 is an exploded perspective view of a first preferred embodiment of an automatic liquid supply planting device in accordance with the present invention;

FIG. 2 is an enlarged side view in partial section of the automatic liquid supply planting device in FIG. 1;

FIG. 3 is an enlarged cross sectional side view of the automatic liquid supply planting device in FIG. 1;

FIG. 4 is an operational side view in partial section of a second preferred embodiment of an automatic liquid supply planting device in accordance with the present invention;

FIG. 5 is an exploded side view in partial cross section of a third preferred embodiment of an automatic liquid supply planting device in accordance with the present invention;

FIG. 6 is an exploded perspective view of a fourth preferred embodiment of an automatic liquid supply planting device in accordance with the present invention;

FIG. 7 is an exploded perspective view of a fifth preferred embodiment of an automatic liquid supply planting device in accordance with the present invention;

FIG. 8 is an exploded perspective view of a sixth preferred embodiment of an automatic liquid supply planting device in accordance with the present invention;

FIG. 9A is an exploded perspective view of a seventh preferred embodiment of an automatic liquid supply planting device in accordance with the present invention; and

FIG. 9B is an enlarged perspective view of FIG. 9A.

### DETAILED DESCRIPTION OF PREFERRED EMBODIMENT

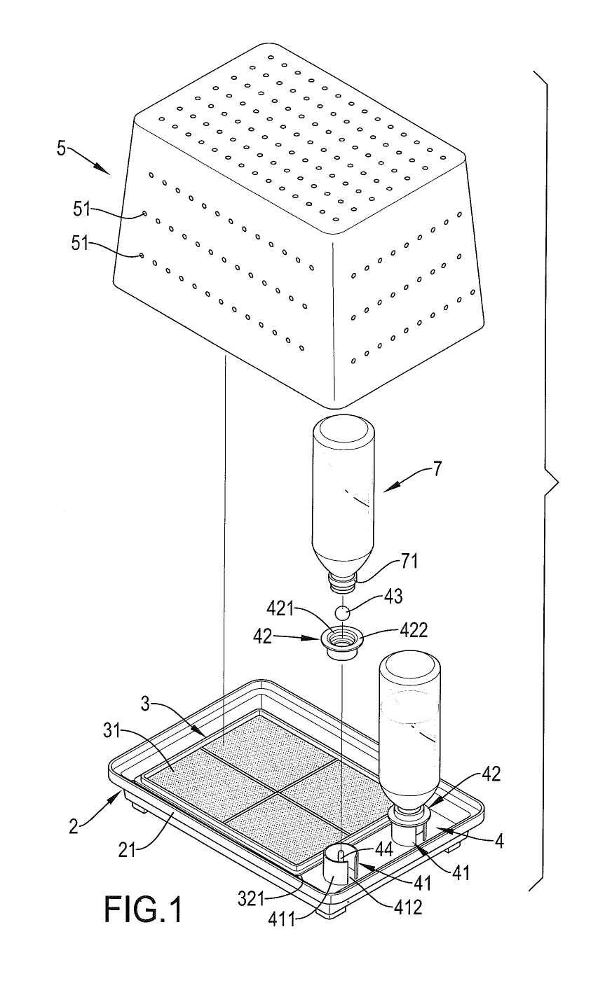

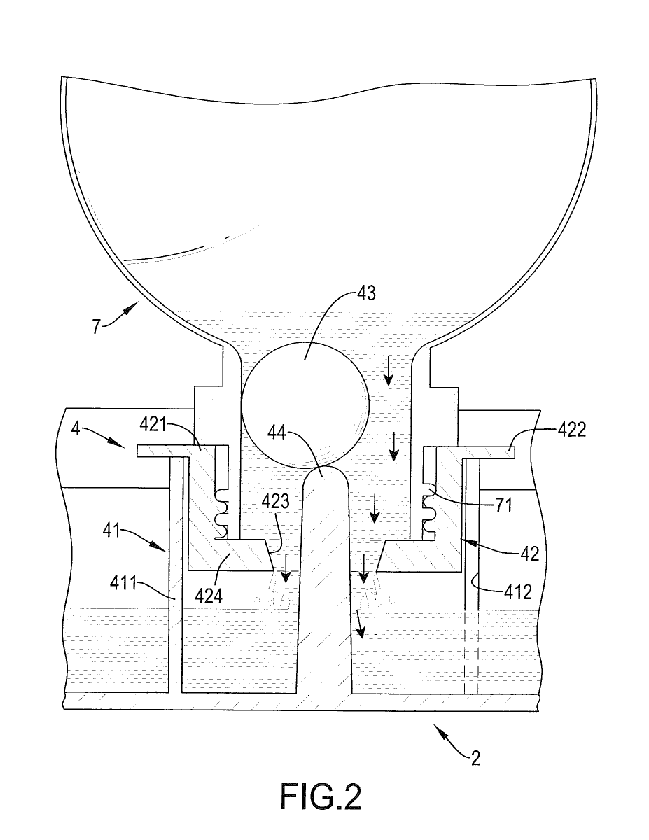

With reference to FIGS. 1 to 3, a first preferred embodiment of an automatic liquid supply planting device in accordance with the present invention has a base 2, a planting holder 3 mounted on the base 2, at least one liquid supply module 4, a tapered top cover 5, and at least one bottle 7.

Each bottle 7 has a combining portion 71 with threads, wherein the combining portion 71 is located at an end of the bottle 7. Preferably, the automatic liquid supply planting device has two liquid supply modules 4 and two bottles 7, and the bottles 7 are respectively mounted on the liquid supply modules 4.

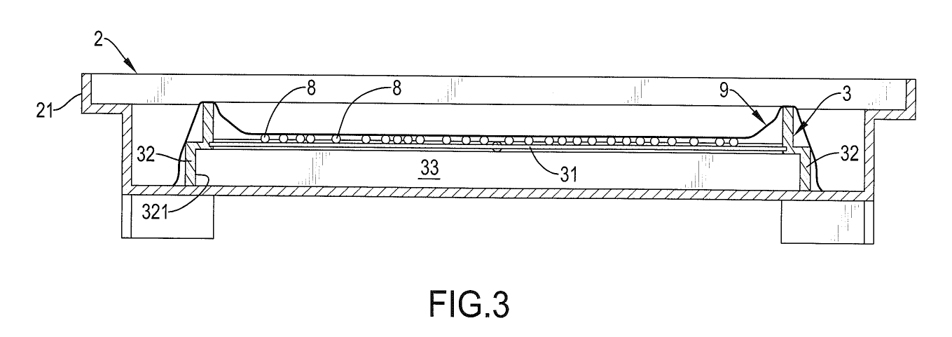

The planting holder 3 has a mesh planting board 31, a guiding plate 32, an opening 321, and an accommodating space 33. The guiding plate 32 is mounted around and extends downward from a bottom of the planting board 31. The opening 321 is formed through two opposite sides of the guiding plate 32, such that a cross section of the guiding plate 32 is U-shaped. Two other sides of the guiding plate 32 protrude out of two sides of the planting board 31, as shown in FIG. 3. The accommodating space 33 is formed between the planting board 31 and the guiding plate 32 and communicates with the opening 321.

The liquid supply modules 4 are mounted on a top of the base 2 and are located at a side of the planting holder 3. Each liquid supply module 4 has a liquid supply base 41, a liquid supply bottle cap 42, an adjusting ball 43, and a pushing post 44. The liquid supply base 41 is fixed on the top of the base 2 and has a surrounding wall 411 and a liquid guiding hole 412. A top of the surrounding wall 411 is horizontal. The liquid guiding hole 412 is longitudinally formed through a side of the surrounding wall 411. The liquid guiding hole 412 is located at the side of the surrounding wall 411 opposite to the opening 321 of the planting holder 3.

The liquid supply bottle cap 42 is detachably mounted on the liquid supply base 41, is combined with the combining portion 71 of the bottle 7, and has a cap body 421, a flange 422, a base wall 424, and a liquid outlet hole 423.

The cap body 421 is annular and is inserted into the surrounding wall 411, abuts the bottle 7, and has an inner thread formed on an inner side of the cap body 421. The liquid supply bottle cap 42 is combined with the combining portion 71 of the bottle 7 by the inner thread of the cap body 421. The flange 422 is annularly formed on an outer side of the cap body 421 and is located at an end of the cap body 421. The flange 422 may be round, rectangular, triangular, or heart-shaped. The flange 422 abuts the surrounding wall 411, such that the liquid supply bottle cap 42 can be mounted on the liquid supply base 41. The base wall 424 is annularly formed on the inner side of the cap body 421 and is located at an end of the cap body 421 opposite to the flange 422. The liquid outlet hole 423 is formed through the base wall 424 and communicates with an inner space of the bottle 7.

The adjusting ball 43 is moveably mounted in the bottle 7 and above the base wall 424 of the liquid supply bottle cap 42. The pushing post 44 is formed on the top of the base 2 and is located inside the liquid supply base 41. In use, the bottle 7 is combined with the liquid supply bottle cap 42, and then the liquid supply bottle cap 42 is mounted on the liquid supply base 41. The pushing post 44 can be inserted through the liquid outlet hole 423 to push the adjusting ball 43 away from the liquid outlet hole 423.

The top cover 5 is detachably mounted on the base 2 and is provided for sheltering multiple sprouts 8 planted on the planting holder 3 to protect the sprouts 8 from dust or insects. The top cover 5 has multiple through holes 51 formed through the top cover 5.

In assembling, the adjusting ball 43 is mounted in the bottle 7, and then a culture liquid is poured into the bottle 7. The combining portion 71 of the bottle 7 is combined with the inner thread of cap body 421 of the liquid supply bottle cap 42, and then the liquid supply bottle cap 42 and the bottle 7 are mounted upside down on the liquid supply base 41.

In use, when a level of the culture liquid in the base 2 is not lower than the liquid outlet hole 423, the culture liquid in the bottle 7 does not flow out of the bottle 7 since a sum of an atmospheric pressure and a liquid pressure in the base 2 is equal to a liquid pressure in the bottle 7. On the other hand, when the level of the culture liquid in the base 2 is lower than the liquid outlet hole 423, the culture liquid in the bottle 7 will flow out of the bottle 7 and flow into the base 2 via the liquid outlet hole 423. Therefore, the culture liquid can self-flow into the base 2 steadily and continuously to provide nutrient sources for the sprouts 8. A user does not need to water the sprouts 8 regularly. It is convenient for the user to plant the sprouts 8.

After the sprouts 8 sprout and root, multiple roots of the sprouts 8 may extend out of the opening 321. The liquid guiding hole 412 can be kept from being blocked by the sprouts 8 since the liquid guiding hole 412 is formed through the side of the surrounding wall 411 opposite to the opening 321. Therefore, a liquid-providing effect of the automatic liquid supply planting device will not be affected. With the abutment of the flange 422 against the surrounding wall 411, the bottle 7 can be mounted on the liquid supply base 41 firmly. The pushing post 44 is inserted into the liquid supply bottle cap 42 to push the adjusting ball 43, such that the adjusting ball 43 can be pushed away from the liquid outlet hole 423, and the culture liquid can flow out from the liquid outlet hole 423. Then, the culture liquid flows into the liquid supply base 41 and then flows into the space under the planting holder 3.

With reference to FIG. 3, in an initial planting period, before the sprouts 8 germinate, a liquid absorbing cloth 9 is mounted on the planting holder 3, supported by the guiding plate 32, covers and touches the sprouts 8. The liquid absorbing cloth 9 can absorb the culture liquid and soaks the sprouts 8 to help the sprouts 8 to germinate. Furthermore, the liquid absorbing cloth 9 can be inserted through the opening 321 into the accommodating space 33 and to absorb the culture liquid. After the sprouts 8 germinate, the roots of the sprouts 8 can self-absorb the culture liquid. Therefore, the liquid absorbing cloth 9 can be omitted.

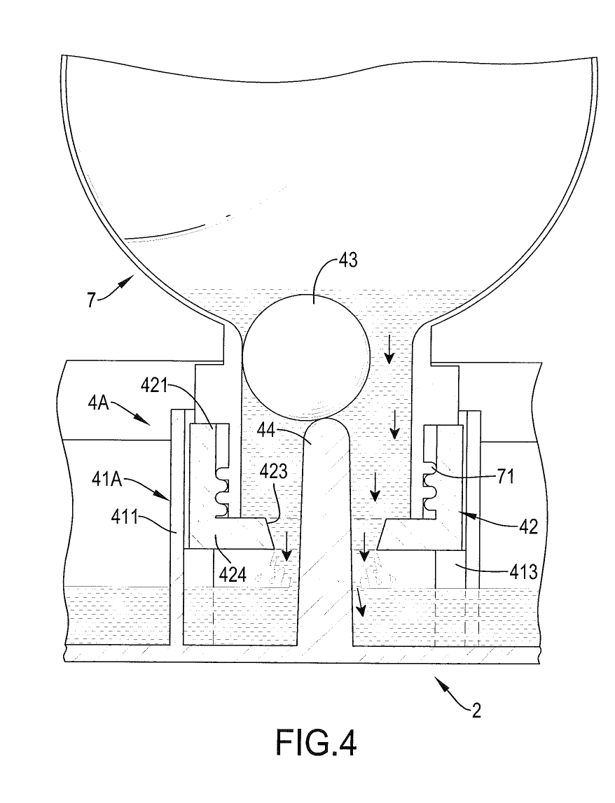

With reference to FIG. 4, a second preferred embodiment of the automatic liquid supply planting device in accordance with the present invention has a different liquid supply module 4A. A liquid supply base 41A of the liquid supply module 4A further has a restricting block 413 formed on an inner side of the surrounding wall 411. A top of the restricting block 413 abuts a bottom of the liquid supply bottle cap 42. The flange 422 in the first preferred embodiment is omitted. The liquid supply bottle cap 42 does not abut the liquid supply base 41A. Therefore, the liquid supply base 41A is merely supported by the restricting block 413.

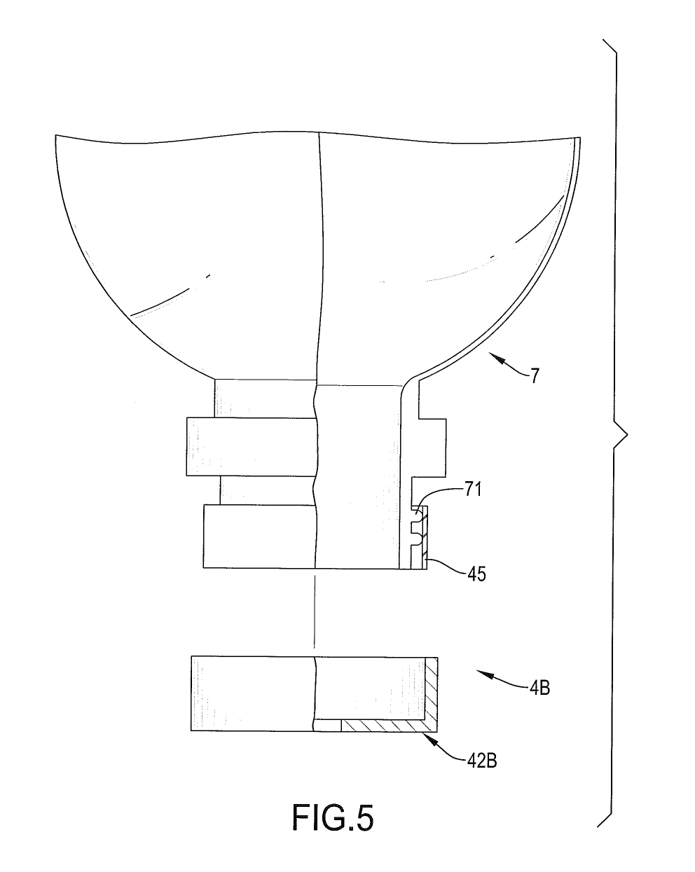

With reference to FIG. 5, a third preferred embodiment of the automatic liquid supply planting device in accordance with the present invention has a different liquid supply module 4B. The inner thread of the liquid supply bottle cap 42B in the first preferred embodiment is omitted. The liquid supply module 4B further has a sealing ring 45 mounted around the combining portion 71 of the bottle 7. The sealing ring 45 may be made of gum, foam material, sponge or so on. When the bottle 7 is mounted on a liquid supply bottle cap 42B of the liquid supply module 4B, the combining portion 71 is combined with the liquid supply bottle cap 42B and the sealing ring 45 can seal gaps between the combining portion 71 and the liquid supply bottle cap 42B. Therefore, the sealing ring 45 can increase a combining strength between the bottle 7 and the liquid supply bottle cap 42B and can prevent leak of the culture liquid.

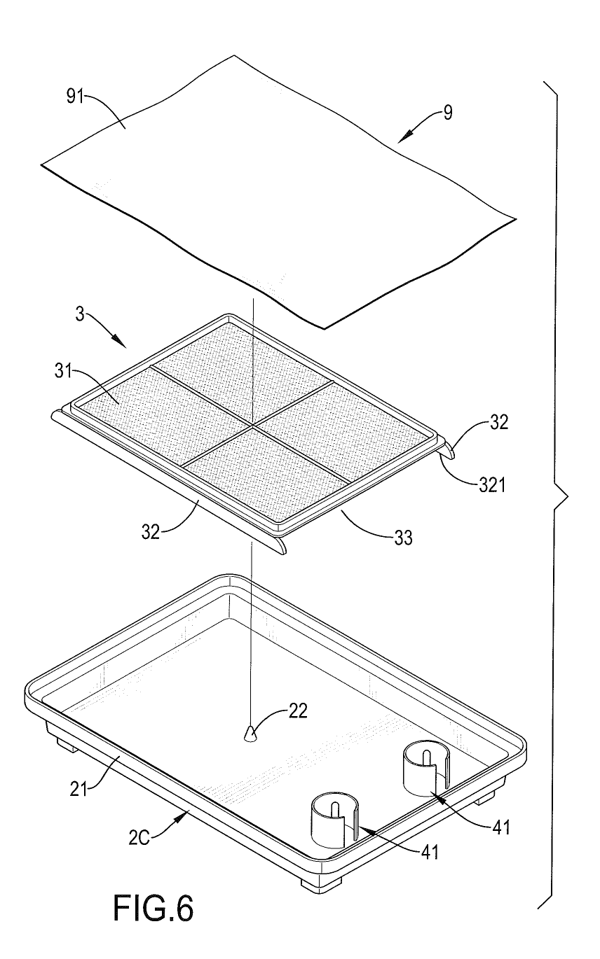

With reference to FIG. 6, a fourth preferred embodiment of the automatic liquid supply planting device in accordance with the present invention has a different base 2C. The base 2C further has a supporting post 22 formed on a base body 21. The supporting post 22 supports a middle of the planting holder 3 to keep the middle of the planting holder 3 from being depressed.

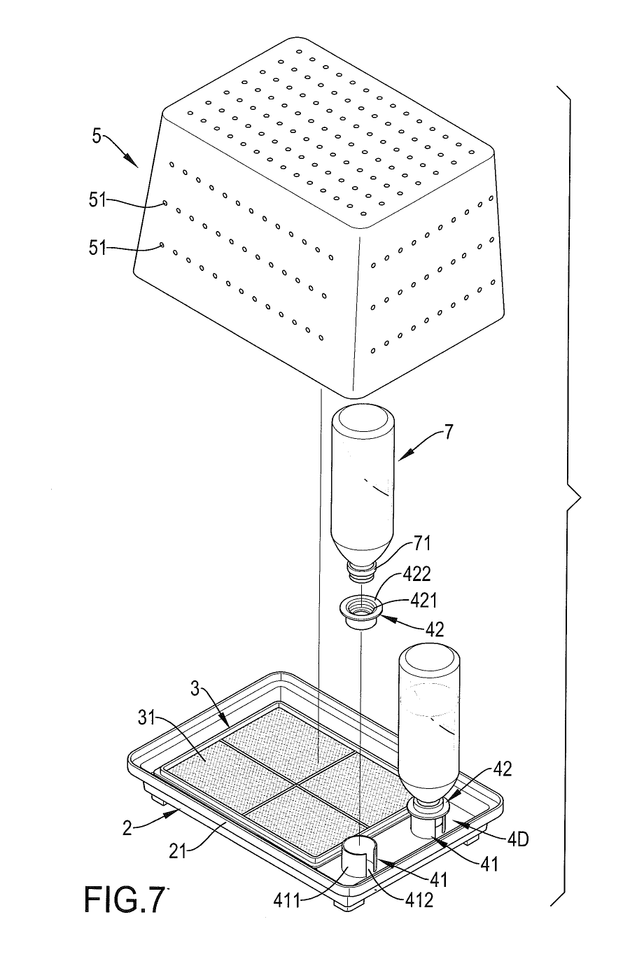

With reference to FIG. 7, a fifth preferred embodiment of the automatic liquid supply planting device in accordance with the present invention has a different liquid supply module 4D, wherein the adjusting ball 43 and the pushing post 44 in the first preferred embodiment shown in FIG. 1 are omitted.

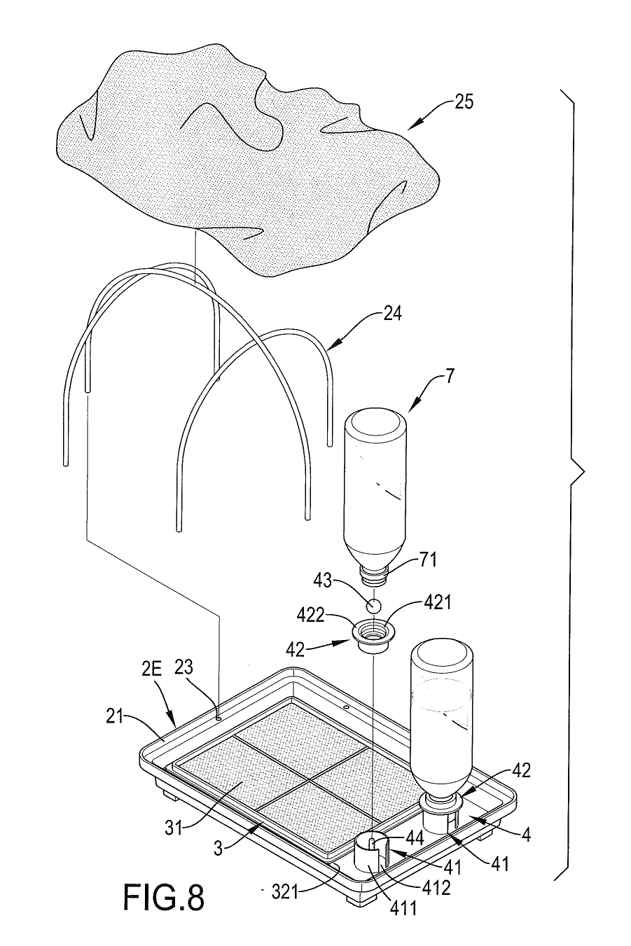

With reference to FIG. 8, a sixth preferred embodiment of the automatic liquid supply planting device in accordance with the present invention has a different base 2E. The base 2E further has multiple fixing holes 23 formed in the base 2E at intervals. The top cover 5 in the first preferred embodiment shown in FIG. 1 is omitted. The automatic liquid supply planting device further has a supporting frame 24 and a mesh cover 25. The supporting frame 24 is arched and is inserted into the fixing holes 23. The mesh cover 25 is mounted on the supporting frame 24 and shelters the base 2E and the planting holder 3 to protect the sprouts from dust or insects.

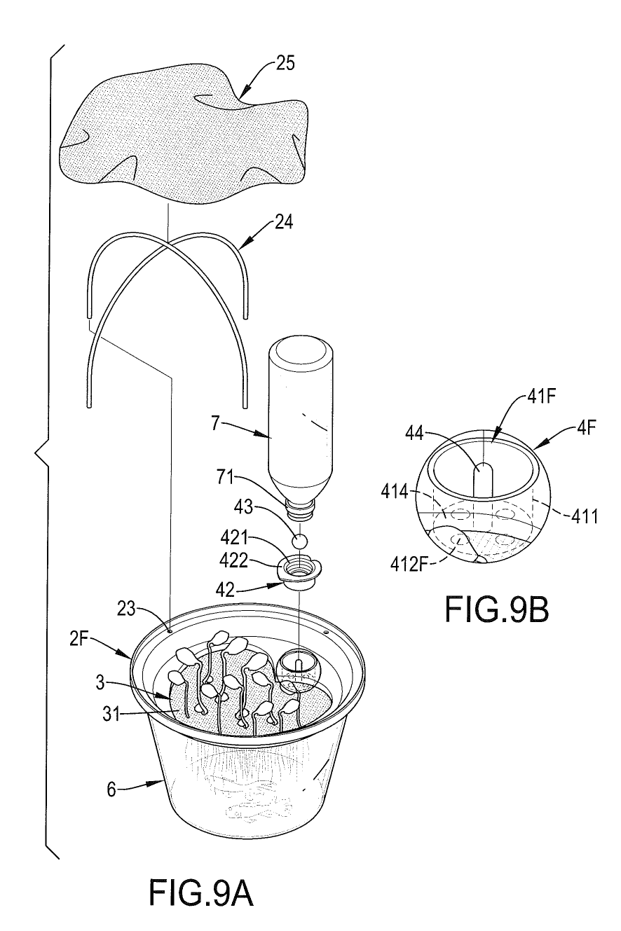

With reference to FIGS. 9A and 9B, a seventh preferred embodiment of the automatic liquid supply planting device in accordance with the present invention further has a liquid storage base 6. The liquid storage base 6 is pervious to light. The base 2F is detachably mounted on the liquid storage base 6. The planting holder 3F is mounted on the base 2F. A top of the surrounding wall 411 is mounted on the base 2F, and the surrounding wall 411 extends downward into the liquid storage base 6. The liquid supply base 41F further has a liquid guiding surface 414. The liquid guiding surface 414 is formed on a bottom of the surrounding wall 411. The liquid guiding hole 412F is formed through the liquid guiding surface 414 and communicates with an inner space of the liquid storage base 6. When the bottle 7 is mounted on the liquid supply module 4F, the culture liquid in the bottle 7 can flow into the liquid supply module 4F and then into the liquid storage base 6 from the at least one liquid guiding hole 412F. After the sprouts germinate, the roots of the sprouts can grow into the liquid storage base 6 to absorb the culture liquid in the liquid storage base 6. Therefore, the liquid storage base 6 can provide a storage effect to extend a time interval for supplying liquid. The user can further keep fishes in the liquid storage base 6. Alternatively, the user can observe growth of the roots of the sprouts since the liquid storage base 6 is pervious to light.

From the above description, it is noted that the present invention has the following advantages:

1. The automatic liquid supply planting device can provide an automatic watering effect for the sprouts 8, such that the user does not have to water the sprouts 8 regularly.

2. The bottle 7 is widely available. The combining portion 71 of the bottle 7 is of a standardized specification, so different bottles 7 in different sizes can be assembled on the liquid supply bottle cap 42 for different usage demands.

3. When multiple automatic liquid supply planting devices are transported and stored, the top covers 5 of the automatic liquid supply planting devices can be stacked, such that cost for transporting and storage can be decreased.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An automatic liquid supply planting device having:
a base;
a planting holder mounted on the base;
a liquid supply module mounted on the base and having
a liquid supply base mounted on the base and having a liquid guiding hole;
a liquid supply bottle cap detachably mounted on the liquid supply base and having
a cap body detachably inserted into the liquid supply base;
a base wall annularly formed around an inner side of the cap body and located at an end of the cap body; and
a liquid outlet hole formed through the base wall and communicating with the liquid guiding hole; and
a bottle detachably combined with the cap body and having an inner space communicating with the liquid outlet hole.

2. The automatic liquid supply planting device as claimed in claim 1, wherein the cap body has an inner thread formed on the inner side of the cap body, wherein the bottle is combined with the inner thread of the cap body.

3. The automatic liquid supply planting device as claimed in claim 2, wherein the liquid supply bottle cap further has a flange annularly formed around an outer side of the cap body, located at another end of the cap body opposite to the base wall, and abutting the liquid supply base.

4. The automatic liquid supply planting device as claimed in claim 3, wherein the liquid guiding hole is located at side of the liquid supply base at a position opposite to the planting holder.

5. The automatic liquid supply planting device as claimed in claim 4, wherein the planting holder has
a planting board;
a guiding plate mounted on and extending downward from a bottom of the planting board, wherein at least one side of the guiding plate protrudes out of a corresponding side of the planting board;
an opening formed through a side of the guiding plate at a position adjacent to the liquid supply module; and
an accommodating space formed between the planting board and the guiding plate, and communicating with the opening.

6. The automatic liquid supply planting device as claimed in claim 2, wherein
the base further has multiple fixing holes formed in the base at intervals; and
the automatic liquid supply planting device further has
a supporting frame being arched and inserted into the fixing holes; and
a mesh cover mounted on the supporting frame and sheltering the base and the planting holder.

7. The automatic liquid supply planting device as claimed in claim 2, wherein
a liquid storage base is detachably mounted under the base;
the planting holder communicates with the liquid storage base; and
the liquid supply base is inserted into the liquid storage base and has
a top mounted on the base; and
a liquid guiding surface formed on a bottom of the liquid supply base, wherein the liquid guiding hole is formed through the liquid guiding surface and communicates with the liquid storage base.

8. The automatic liquid supply planting device as claimed in claim 2, wherein the liquid supply base further has a restricting block formed on an inner side of the liquid supply base, wherein the liquid supply bottle cap abuts the restricting block.

9. The automatic liquid supply planting device as claimed in claim 2, wherein the base further has a supporting post formed on the base and supporting the planting holder.

10. The automatic liquid supply planting device as claimed in claim 1, wherein the liquid supply module further has a sealing ring mounted around an end of the bottle and sealing gaps between the bottle and the cap body.

11. The automatic liquid supply planting device as claimed in claim 1, wherein the liquid supply module further has
an adjusting ball moveably mounted in the bottle and sheltering part of the liquid outlet hole; and
a pushing post formed on the base, located inside the liquid supply base, inserted into the liquid supply bottle cap via the liquid outlet hole, and abutting the adjusting ball.

12. The automatic liquid supply planting device as claimed in claim 2, wherein the liquid supply module further has
an adjusting ball moveably mounted in the bottle and sheltering part of the liquid outlet hole; and
a pushing post formed on the base, located inside the liquid supply base, inserted into the liquid supply bottle cap via the liquid outlet hole, and abutting the adjusting ball.

13. The automatic liquid supply planting device as claimed in claim 3, wherein the liquid supply module further has
an adjusting ball moveably mounted in the bottle and sheltering part of the liquid outlet hole; and
a pushing post formed on the base, located inside the liquid supply base, inserted into the liquid supply bottle cap via the liquid outlet hole, and abutting the adjusting ball.

14. The automatic liquid supply planting device as claimed in claim 4, wherein the liquid supply module further has
an adjusting ball moveably mounted in the bottle and sheltering part of the liquid outlet hole; and
a pushing post formed on the base, located inside the liquid supply base, inserted into the liquid supply bottle cap via the liquid outlet hole, and abutting the adjusting ball.

15. The automatic liquid supply planting device as claimed in claim 5, wherein the liquid supply module further has
an adjusting ball moveably mounted in the bottle and sheltering part of the liquid outlet hole; and
a pushing post formed on the base, located inside the liquid supply base, inserted into the liquid supply bottle cap via the liquid outlet hole, and abutting the adjusting ball.

16. The automatic liquid supply planting device as claimed in claim 6, wherein the liquid supply module further has
an adjusting ball moveably mounted in the bottle and sheltering part of the liquid outlet hole; and
a pushing post formed on the base, located inside the liquid supply base, inserted into the liquid supply bottle cap via the liquid outlet hole, and abutting the adjusting ball.

17. The automatic liquid supply planting device as claimed in claim 7, wherein the liquid supply module further has
an adjusting ball moveably mounted in the bottle and sheltering part of the liquid outlet hole; and
a pushing post formed on the base, located inside the liquid supply base, inserted into the liquid supply bottle cap via the liquid outlet hole, and abutting the adjusting ball.

18. The automatic liquid supply planting device as claimed in claim 8, wherein the liquid supply module further has
an adjusting ball moveably mounted in the bottle and sheltering part of the liquid outlet hole; and
a pushing post formed on the base, located inside the liquid supply base, inserted into the liquid supply bottle cap via the liquid outlet hole, and abutting the adjusting ball.

19. The automatic liquid supply planting device as claimed in claim 9, wherein the liquid supply module further has
an adjusting ball moveably mounted in the bottle and sheltering part of the liquid outlet hole; and
a pushing post formed on the base, located inside the liquid supply base, inserted into the liquid supply bottle cap via the liquid outlet hole, and abutting the adjusting ball.

20. The automatic liquid supply planting device as claimed in claim 10, wherein the liquid supply module further has
an adjusting ball moveably mounted in the bottle and sheltering part of the liquid outlet hole; and
a pushing post formed on the base, located inside the liquid supply base, inserted into the liquid supply bottle cap via the liquid outlet hole, and abutting the adjusting ball.
